(19) United States
(12) Patent Application Publication
(10) Pub. No.: US 2005/0271939 A1
(43) Pub. Date: Dec. 8, 2005

(54) Novel polymer electrolyte for electrochemical power sources

(76) Inventors: Yang Xu, Northborough, MA (US); Carl Schlaikjer, Concord, MA (US)

Correspondence Address: WILSON GREATBATCH TECHNOLOGIES, INC., 10,000 WEHRLE DRIVE, CLARENCE, NY, 14031, US

(21) Appl. No.: 10/929,235

(22) Filed: Aug. 30, 2004

Related U.S. Application Data
(60) Provisional application No. 60/577,716, filed on Jun. 7, 2004.

(51) Int. Cl. H01M 10/40; H01M 4/54; H01M 4/50

(52) U.S. Cl. 429/189; 429/317; 429/314; 429/307; 429/231.5; 429/219; 429/220; 429/224

(57) ABSTRACT

A homogeneous single-phase polymer electrolyte containing a cyano monomer cross-linked with a second monomer having at least one α-unsaturated functionality, is described. A mixture of 2-cyanoethyl acrylate and a second monomer having α-unsaturated functionalities, such as multi-functional (meth)acrylates is preferred. The polymer electrolyte further includes a thermally activated initiator and a solvent system containing an ionizable salt. The preferred electrolyte is a polar aprotic organic compound having at least one ionizable lithium salt dissolved therein.

### CROSS REFERENCE TO RELATED APPLICATION

This application claims priority from provisional application Ser. No. 60/577,716, filed Jun. 7, 2004.

### BACKGROUND OF THE INVENTION

1. Field of the Invention

The invention relates to electrochemical cells generating electrical energy by means of chemical reaction. More specifically, the invention provides an improved polymer electrolyte for use in both primary and rechargeable electrochemical cells. The electrolyte allows for better rate capability and cycle life than those produced by the current state-of-the-art battery electrolytes.

2. Prior Art

Electrochemical cells activated with solid polymer electrolytes containing dissolved metal salts have been proposed as an alternative to liquid electrolytes in primary lithium and rechargeable lithium ion systems. The prior art has proposed many different polymer matrices and processes. For example, U.S. Pat. No. 5,609,974 to Sun, which is assigned the assignee of the present invention and incorporated herein by reference, discloses a polymer electrolyte initially composed of three monomers, a plasticizer, a lithium salt, and a thermal initiator. The purpose of one of the monomers is to lend flexibility to the polymer, another one provides a high dielectric constant, and the final one is a cross-linking agent. Before polymerization, the monomer and plasticizer mixture complexes with the lithium salt at the molecular level. The mixture is capable of producing a thin film with suitable mechanical properties in a single, homogeneous phase that does not separate over time, or when heated. Thus, the mixture produces a superior electrolyte for use in a rechargeable cell in comparison with other prior art systems.

Ethylene glycol ethyl carbonate methacrylate (EGECM) is the monomer that provides the relatively high dielectric constant. The high dipole moment of the carbonate group is instrumental in providing this characteristic. The cyano entity also has a high dipole moment, and is capable of producing compounds with high dielectric constants. It is noted, for example, that electrolytes based on acrylonitrile monomer (AN) have relatively high conductivities. However, the acrylonitrile monomer is a dangerous carcinogen.

State of the art polymer electrolyte cells with single phase electrolytes have already have been described, but none safely take advantage of the highly polar nitrile(cyano) group to enhance conductivity and rate capability.

### SUMMARY OF THE INVENTION

The invention is directed to a homogeneous single-phase polymer electrolyte containing cyano groups. The cyano monomer is cross-linked with a second monomer having at least one α-unsaturated functionality, and more preferably multiple α-unsaturated functionalities, such as multi-functional (meth)acrylates. The multi-functional (meth)acrylates provide the polymer electrolyte as one that is relatively rapidly curable inside a cell casing to form a cross-linked matrix or network. The polymer electrolyte further includes a thermally activated initiator and a solvent system containing an ionizable salt. The preferred electrolyte is a polar aprotic organic compound having at least one ionizable lithium salt dissolved therein. The resulting polymer has similar mechanical properties as the previously discussed state-of-the art electrolyte in U.S. Pat. No. 5,609,974 to Sun while providing improved rate capability and cycle life.

Accordingly, the invention relates to an electrochemical cell comprising: a casing; a negative electrode comprising an anode active material contacted to an anode current collector; a positive electrode comprising a cathode active material contacted to a positive current collector; and a flexible polymer between the negative and positive electrodes acting both as an electrolyte and as a separator. The electrolyte comprises: a first monomer comprising a acryloyl or allyl functionality plus a cyano group; a second monomer comprising at least one α-unsaturated functionality; and a thermal initiator mixed with an alkali metal salt and at least one organic solvent.

These and other objects of the present invention will become increasingly more apparent to those skilled in the art by a reading of the following detailed description in conjunction with the appended drawings.

### BRIEF DESCRIPTION OF THE DRAWINGS

FIG. 1 shows a plot of discharge capacity versus cycle number of a representative present invention and prior art cell.

FIG. 2 shows a plot of potential versus discharge capacity of various present invention cells.

### DETAILED DESCRIPTION OF THE PREFERRED EMBODIMENTS

The present polymer electrolyte is prepared from a mixture including the monomer 2-cyanoethyl acrylate (CEA) cross-linked with a second monomer. It is known that the more double bonds a monomer has, the more rapidly it will polymerize. Dipentaerythritol hexaacrylate, a monomer with six double bonds, is capable of polymerization at a high rate. Multifunctional monomers also produce desirable crosslinking in polymers. A third advantage is that the resulting polymer has a lower viscosity than a polymer created from a monomer with just one functional group. However, the mechanical strength of a polymer prepared from a single multifunctional monomer, even one having six double bonds, is relatively low. Combining a second monomer, even one having only one functional group, with DPHA increases the mechanical strength of the resulting electrolyte and lends it flexibility.

Accordingly, a polymer electrolyte for a solid state electrochemical cell is made according to the present invention by polymerizing a thin layer of a solution containing a first monomer having one acryloyl or allyl functionality plus a cyano group cross linked with a second monomer having at least one α-unsaturated functionality. The highly polar compound 2-cyanoethyl acrylate (CEA) is preferred as the first monomer. CEA is only an irritant, in contrast with the known carcinogen AN.

Purified CEA is not commercially available, however, because of its limited stability when heated. If distillation of the technical grade commercial product is attempted, polymerization nearly always occurs. Instead, the commercially available material can be co-distilled with water in vacuo. The wet azeotrope is distilled at a temperature slightly lower than that of the dry ester, during which time the water vapor inhibits polymerization. Equilibrating with molecular sieves, for example type 3A, at ambient temperature is suitable for drying the distilled product.

Suitable polymerizerable monomers having at least one α-unsaturated functionality, and more preferably multiple α-unsaturated functionalities, such as multi-functional (methyl)acryloyl monomers, are relatively rapidly curable to form a cross-linked matrix or network. Preferably, the (methyl)acryloyl monomer has at least one appended group selected from alkyl, alkyl ether, alkoxylated alkyl and alkylated phenol groups. Suitable monomers include dipentaerythritol hexaacrylate (DPHA), dipentaerythritol pentaacrylate (DPAA), pentaerythritol tetraacrylate, ethoxylated pentaerythritol tetraacrylate, di(trimethylolpropane)tetraacrylate (DTMPTA), trimethylolpropane trimethacrylate, ethoxylated trimethylolpropane triacrylate (ETMPTA), ethoxylated bisphenol diacrylate, hexanediol diacrylate, and mixtures thereof. DPHA is preferred. This polymerizable monomer has six acryloyl functional groups, which means it readily serves as a crosslinking agent by accelerating the polymerization rate and providing low viscosity for the resulting solid polymer electrolyte. If desired, the cross-linking can take place inside a cell casing.

The polymer electrolyte includes at least one polar aprotic organic solvent selected from cyclic carbonates, cyclic esters, cyclic amides and dialkyl carbonates. Preferred are propylene carbonate (PC), ethylene carbonate (EC), and butylene carbonate (BC), and mixtures thereof. Less preferred are acetonitrile, dimethyl sulfoxide, dimethyl formamide, dimethyl acetamide, γ-valerolactone, γ-butyrolactone (GBL), N-methyl-pyrrolidinone (NMP), and mixtures thereof. Cyclic carbonates are most preferred. Preferably, a binary solvent mixture is used, such as one of EC/PC.

An ionizable lithium salt is preferred for electrochemical cells having lithium as the anode active material. Suitable salts are selected from LiPF₆, LiBF₄, LiAsF₆, LiSbF₆, LiClO₄, Li[(C₂O₄)₂B], Li₂B₁₀Cl₁₀, Li₂B₁₀Br₁₀, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₃F, LiB(C₆H₅)₄, LiCF₃SO₃, and mixtures thereof.

Suitable thermal initiators as free-radical generating compounds include benzoyl peroxide (BPO), 1,1′-azobis(cyclohexanecarbonitrile) (ACN), 4,4-azobis(4-cyanovaleric acid), lauroyl peroxide, 1,1-bis(tert-butylperoxy)cyclohexane, 1,1-bis(tert-amylperoxy)cyclohexane, and mixtures thereof.

The monomers are present in the polymer electrolyte precursor solution in a concentration of about 4% to about 15%, by weight. The concentration of the thermal initiator is about 0.3% to about 1.0%, by weight, of the electrolyte solution. The thusly-prepared polymer electrolyte precursor solution is a free-flowing liquid of relatively low viscosity.

The polymerization of this solution results in the formation of a homogeneous solid polymer electrolyte film devoid of any free-flowing liquid and without phase separation.

The present polymer electrolytes are useful in a wide variety of electrochemical power sources. These include primary electrochemical cells, such as of the lithium/silver vanadium oxide (Li/SVO), lithium/copper silver vanadium oxide (Li/CSVO), and lithium/manganese oxide (Li/MnO₂) couples. Exemplary Li/SVO cells are described in U.S. Pat. Nos. 4,310,609 and 4,391,729, both to Liang et al., and U.S. Pat. No. 5,580,859 to Takeuchi et al. while an exemplary Li/CSVO cell is described in U.S. Pat. Nos. 5,472,810 and 5,516,340, both to Takeuchi et al. All of these patents are assigned to the assignee of the present invention and incorporated herein by reference.

The polymer electrolytes of the present invention are also useful for activating secondary electrochemical cells. In a secondary system, the negative electrode comprises a material capable of intercalating and de-intercalating the active material, such as the preferred alkali metal lithium. A carbonaceous negative electrode comprising any of the various forms of carbon (e.g., coke, graphite, acetylene black, carbon black, glassy carbon, “hairy carbon” etc.) that are capable of reversibly retaining the lithium species is preferred for the negative electrode material. A “hairy carbon” material is particularly preferred due to its relatively high lithium-retention capacity. “Hairy carbon” is a material described in U.S. Pat. No. 5,443,928 to Takeuchi et al., which is assigned to the assignee of the present invention and incorporated herein by reference. Graphite is another preferred material. Regardless of the form of the carbon, fibers of the carbonaceous material are particularly advantageous because they have excellent mechanical properties that permit them to be fabricated into rigid electrodes capable of withstanding degradation during repeated charge/discharge cycling. Moreover, the high surface area of carbon fibers allows for rapid charge/discharge rates.

Also in secondary systems, the positive electrode preferably comprises a lithiated material that is stable in air and readily handled. Examples of such air-stable lithiated cathode active materials include oxides, sulfides, selenides, and tellurides of such metals as vanadium, titanium, chromium, copper, molybdenum, niobium, iron, nickel, cobalt and manganese. The more preferred oxides include LiNiO₂, LiMn₂O₄, LiCoO₂, LiCo_{0.92}Sn_{0.08}O₂, LiCo₁₋ₓNiₓO₂, and LiFePO₄.

The present electrolytes are not only useful in primary and secondary electrochemical cells, they are useful in capacitors as well. This includes conventional electrolytic capacitors, as well as those of an electrolytic/electrochemical hybrid type. Capacitor cathodes commonly used in electrolytic capacitors include etched aluminum foil in aluminum electrolytic capacitors, and those commonly used in wet tantalum capacitors such as of silver, sintered valve metal powders, platinum black, and carbon. The cathode of hybrid capacitors include a pseudocapacitive coating of a transition metal oxide, nitride, carbide or carbon nitride, the transition metal being selected from the group consisting of ruthenium, cobalt, manganese, molybdenum, tungsten, tantalum, iron, niobium, iridium, titanium, zirconium, hafnium, rhodium, vanadium, osmium, palladium, platinum, and nickel. The pseudocapacitive coating is deposited on a conductive substrate such as of titanium or tantalum. The electrolytic/electrochemical hybrid capacitor has high energy density and is particularly useful for implantable medical devices such as a cardiac defibrillator.

The anode is of a valve metal consisting of the group vanadium, niobium, tantalum, aluminum, titanium, zirconium and hafnium. The anode can be a foil, etched foil, sintered powder, or any other form of porous substrate of these metals.

A preferred chemistry for a hybrid capacitor comprises a cathode of a porous ruthenium oxide film provided on a titanium substrate coupled with an anode of a sintered tantalum powder pressed into a pellet. A suitable separator material impregnated with the present working electrolyte segregates the cathode and anode from each other. Such a capacitor is described in U.S. Pat. No. 5,894,403 to Shah et al., U.S. Pat. No. 5,920,455 to Shah et al. and U.S. Pat. No. 5,926,362 to Muffoletto et al. These patents are assigned to the assignee of the present invention and incorporated herein by reference.

Electrochemical cells and capacitors prepared according to this invention exhibit a completely cured gel polymer electrolyte and good adhesion exists between the electrodes and the solid polymer electrolyte. Such cells and capacitors are dischargeable and cycleable from about −20° C. to about 50° C.

The following examples describe the manner and process of an electrochemical cell according to the present invention, and they set forth the best mode contemplated by the inventors of carrying out the invention, but they are not to be construed as limiting.

In the examples, all concentrations of solvents, salts, and monomers are stated in weight percent (wt %) of the mixture.

### EXAMPLE I

An electrolyte solution was prepared as follows: LiPF₆ was dissolved in a mixture consisting of ethylene carbonate and propylene carbonate. The proportions of each component are shown in Table 1. A polymerization initiator of 1,1′azobis(cyclohexanecarbonitrile) (ACN) was added to this solution. The monomers DPHA and CEA were then added to the solution. The final homogeneous mixture was then spread onto a thin, highly porous fabric supported on a sheet of plastic film, such as that commercially available under the designation KALADEX™. This assembly was then heated at about 80° C. to initiate and complete the polymerization reaction within about 16 minutes. After cooling to room temperature, a freestanding film about 2 mils thick was obtained.

### EXAMPLE II

A second electrolyte solution was prepared according to the same methods disclosed in Example I, except the monomer 2-ethoxyethyl methacrylate (EM) replaced CEA. The proportions of each component are shown in Table 1.

### COMPARATIVE EXAMPLE I

In this example, a control electrolyte was prepared according to the previously discussed U.S. Pat. No. 5,609,974 to Sun. In particular, the solution contained 13.4 wt % LiPF₆, 23.9 wt % PC, 47.8 wt % EC, 7.4 wt % EM, 4.9 wt % EGECM, 1.7 wt % tri(ethylene glycol)dimethacrylate (TEDM), and 0.9 wt % BPO.

Table 1 also lists the compositions and ion conductivities of polymer films prepared according to Examples I and II and Comparative Example I, and the percentage of unreacted monomer in each of the polymer films. Compared with the prior art polymer film, solid polymer electrolyte films of the present invention had higher conductivities and lower amounts of unreacted monomer.

TABLE 1
Compositions and Conductivities of Electrolyte Solutions

| Solution | LiPF₆ | EC/PC | CEA | DPHA | EM | ACN | Conductivity | Unreacted |
|---|---|---|---|---|---|---|---|---|
| (Ex.) | (wt %) | (wt %) | (wt %) | (wt %) | (wt %) | (wt %) | (10⁻³ S/cm) | Monomers % |
| IA | 11.5 | 77.6 | 5.0 | 5.0 | | 0.9 | 1.33 | Undetectable |
| IB-1 | 11.8 | 79.3 | 8.0 | | | 0.9 | 1.45 | Undetectable |
| IB-2 | 11.8 | 79.3 | 6.0 | 2.0 | | 0.9 | 1.81 | Undetectable |
| IB-3 | 11.8 | 79.3 | 4.0 | 4.0 | | 0.9 | 1.98 | About 0.01 wt % |
| IB-4 | 11.8 | 79.3 | 2.0 | 6.0 | | 0.9 | 1.62 | About 0.01 wt % |
| IB-5 | 11.8 | 79.3 | | 8.0 | | 0.9 | 1.12 | About 0.02 wt % |
| IC | 12.2 | 80.9 | 3.0 | 3.0 | | 0.9 | 2.50 | About 0.01 wt % |
| IIA | 11.5 | 77.6 | | 5.0 | 5.0 | 0.9 | 1.25 | About 0.03 wt % |
| IIB | 11.8 | 79.3 | | 4.0 | 4.0 | 0.9 | 1.47 | About 0.04 wt % |
| IIC | 12.2 | 80.9 | | 3.0 | 3.0 | 0.9 | 2.27 | About 0.04 wt % |
| Comp. | | | | | | | 1.06 | 1.87 wt % |
| IA* | | | | | | | | |

### EXAMPLE III

A plurality of lithium ion polymer rechargeable cells was constructed. The negative electrode consisted of a copper foil, 2.7 cm by 2.7 cm, having a thick-mix of graphite coated thereon. The negative active mixture consisted of 51.9 wt % graphite, 7.0 wt % acetylene black, 19.0 wt % EC, 9.5 wt % PC, 7.5 wt % PVDF, and 5.1 wt % LiPF₆. This electrode had a terminal pin for connection to an external circuit.

The positive electrode consisted of an aluminum foil, 2.54 cm by 2.54 cm, having a thick-mix contacted thereto. The active coating consisted of 58.8 wt % LiCoO₂, 3.9 wt % graphite, 3.5 wt % acetylene black, 16.3 wt % EC, 8.1 wt % PC, 4.9 wt % poly(vinylidine difluoride) (PVDF), and 4.5 wt % LiPF₆. The positive electrode also had a terminal extension for connection it to an external circuit.

The cells were activated with a solid polymer electrolyte prepared by Examples I or II or Comparative Example I. The solid polymer electrolyte film was sandwiched between the positive and negative electrodes and the cells were individually sealed in a metallized plastic bag. The cells were charged to a cutoff potential of 4.2 V using either a constant current, or a constant current/constant potential program, and discharged at a constant current, decreasing to a cutoff potential of 2.75 V. During cycling, the charge current density was identical to the discharge current density, namely, 1.18 mA/cm². Table 2 summarizes the capacities of the cells prepared, according to the procedures listed in Examples I and II and Comparative Example I as a function of cycle number.

TABLE 2
Discharge capacity (mAh) / Cycle number

| Cell No. | (3^{rd}) | 120^{th} | 240^{th} | 360^{th} | 480^{th} |
|---|---|---|---|---|---|
| IA-1 | 20.12 | 18.56 | 17.82 | 17.21 | 16.65 |
| | | 92.2% | 88.6% | 85.5% | 82.8% |
| IA-3-1 | 20.48 | 19.06 | 18.23 | 17.24 | 16.38 |
| | | 93.1% | 89.0% | 84.2% | 80.0% |
| IB-3-2 | 20.24 | 18.83 | 17.87 | 17.23 | 16.38 |
| | | 91.9% | 87.3% | 84.1% | 80.9% |
| IC-1 | 20.08 | 18.76 | 18.11 | 17.33 | 16.77 |
| | | 93.4% | 90.2% | 86.3% | 83.5% |
| IIA-1 | 18.51 | 17.13 | 16.29 | 15.41 | 14.99 |
| | | 92.5% | 88.0 | 83.3 | 81.0% |
| IIB-1 | 19.83 | 18.15 | 17.07 | 15.99 | 14.53 |
| | | 91.5% | 86.1% | 80.6% | 73.3% |
| IIB-1 | 20.35 | 18.94 | 18.02 | 17.33 | 16.59 |
| | | 93.1% | 88.6% | 85.2% | 81.5% |
| Comp. | 19.08 | 17.20 | 16.18 | 15.38 | 14.81 |
| IA-1 | | 90.0% | 84.6% | 80.4% | 77.6% |
| Comp. | 20.34 | 18.43 | 16.93 | 15.52 | 13.25 |
| IA-2 | | 91.3% | 83.9% | 76.9% | 65.1% |

These results show that in the case where the solid-polymer electrolyte film is prepared with CEA and DPHA, the cycle life of the rechargeable cells is significantly improved over those cells activated with the competing electrolytes. The cells of Example 1 prepared with CEA and DPHA maintained an average discharge capacity of about 81.8% after 480 cycles. This capacity corresponds to an average fade rate of about 0.0379% per cycle. In addition, the cycling performance of the two control cells (Comparative Example I) with a solid-polymer electrolyte made according to U.S. Pat. No. 5,609,974 to Sun maintained an average discharge capacity of only 71.35 wt % after 480 cycles. This corresponds to an average fade rate of 0.0597 wt % per cycle. Remembering back to Table 1, the-prior art electrolyte film contained 1.87 wt % unreacted monomer.

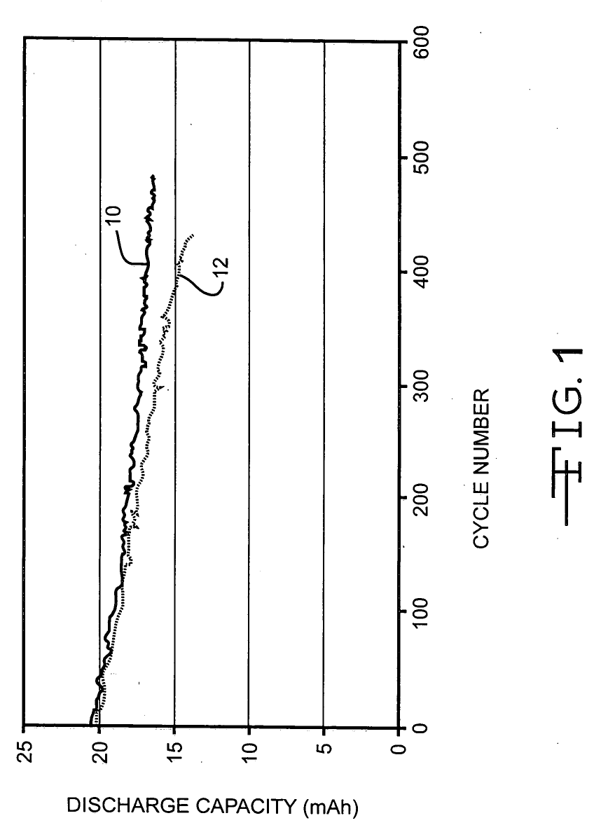

FIG. 1 compares the cycling performance of experimental cells from Example I and Comparative Example I. In particular, curve 10 was constructed from the cycling discharge results of cell IC-1 while curve 12 was constructed from the cycling results of cell Comp. IA-2. The results show that the capacity of the cell made using CEA and DPHA (curve 10) decreased at about a steady rate; however, the capacity of the control cell made in Comparative Example I (curve 12) decreased at a greater rate after about 150 cycles.

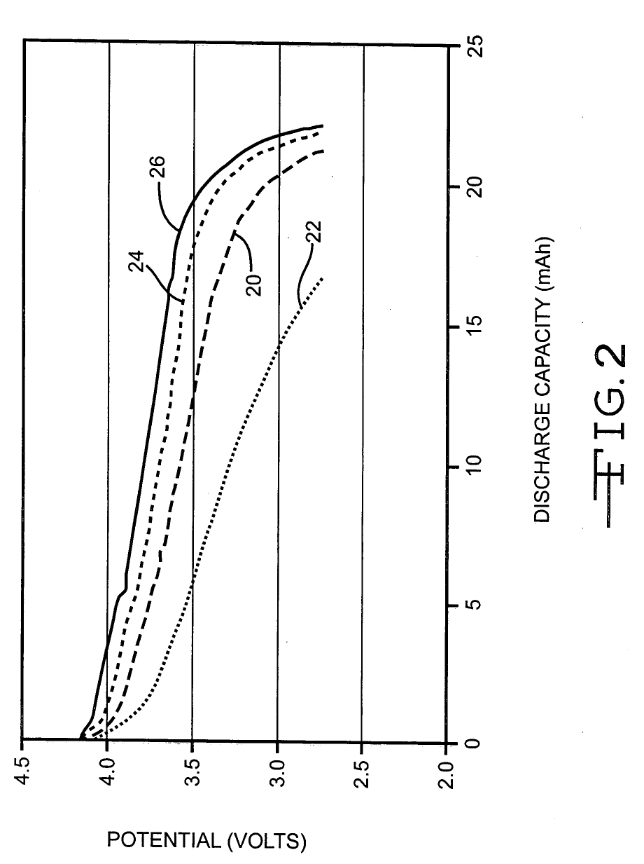

FIG. 2 is a graph of electric potential plotted as a function of discharge capacity for various cells made according to Example I and discharged at various rates. The experiment shows that at room temperature greater than 96% of the rated capacity is retained when the cell is discharged at a 1C rate (curve 20), and about 76% of the rated capacity is retained when the cell is discharged at a 2C rate (curve 22). Curves 24 and 26 were constructed from cells discharge rates of 0.5C and 0.2C, respectively.

It is appreciated that various modifications to the present inventive concepts described herein may be apparent to those of ordinary skill in the art without departing from the spirit and scope of the present invention as defined by the herein appended claims.

1. An electrochemical cell, comprising:
a) a casing;
b) a negative electrode comprising an anode active material contacted to an anode current collector;
c) a positive electrode comprising a cathode active material contacted to a positive current collector;
d) a separator intermediate the negative and positive electrodes; and
e) an electrolyte comprising:
i) a first monomer comprising a acryloyl or allyl functionality plus a cyano group;
ii) a second monomer comprising at least one α-unsaturated functionality; and
iii) a thermal initiator mixed with an alkali metal salt and at least one organic solvent.

2. The electrochemical cell of claim 1 wherein the first monomer is 2-cyanoethyl acrylate.

3. The electrochemical cell of claim 1 wherein second monomer has more than one (methyl)acryloyl functionality.

4. The electrochemical cell of claim 3 wherein the (methyl)acryloyl second monomer has at least one appended group selected from alkyl, alkyl ether, alkoxylated alkyl, and alkylated phenol functional groups.

5. The electrochemical cell of claim 1 wherein the second monomer is selected from the group consisting of dipentaerythritol hexaacrylate, dipentaerythritol pentaacrylate, pentaerythritol tetraacrylate, ethoxylated pentaerythritol tetraacrylate, di(trimethylolpropane)tetraacrylate, trimethylolpropane trimethacrylate, ethoxylated trimethylolpropane triacrylate, ethoxylated bisphenol diacrylate, hexanediol diacrylate, and mixtures thereof.

6. The electrochemical cell of claim 1 wherein the combined concentrations of the first and second monomers in the electrolyte is about 4% to about 15%, by weight.

7. The electrochemical cell of claim 1 wherein the organic solvent is selected from the group consisting of propylene carbonate, ethylene carbonate, butylene carbonate, acetonitrile, dimethyl sulfoxide, dimethyl formamide, dimethyl acetamide, γ-valerolactone, γ-butyrolactone, N-methyl-pyrrolidinone, and mixtures thereof.

8. The electrochemical cell of claim 1 wherein the initiator is selected from the group consisting of 1,1′-azobis(cyclohexanecarbonitrile), benzoyl peroxide, 4,4-azobis(4-cyanovaleric acid), lauroyl peroxide, 1,1-bis(tert-butylperoxy)cyclohexane, 1,1-bis(tert-amylperoxy)cyclohexane, and mixtures thereof.

9. The electrochemical cell of claim 1 wherein the initiator is present in the electrolyte in a concentration of, by weight, about 0.3% to about 1%.

10. The electrochemical cell of claim 1 wherein the alkali metal salt is selected from the group consisting of LiPF₆, LiBF₄, LiAsF₆, LiSbF₆, LiClO₄, Li[(C₂O₄)₂B], Li₂B₁₀Cl₁₀, Li₂B₁₀, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₃F, LiB(C₆H₅)₄, LiCF₃SO3, and mixtures thereof.

11. The electrochemical cell of claim 1 of a primary chemistry selected from lithium/silver vanadium oxide, lithium/copper silver vanadium oxide, and lithium/manganese oxide.

12. The electrochemical cell of claim 1 of a secondary chemistry comprising an anode active material selected from the group consisting of coke, graphite, acetylene black, carbon black, glassy carbon, hairy carbon, and mixtures thereof, and a cathode active material selected from the group consisting of oxides, sulfides, selenides, and tellurides of vanadium, titanium, chromium, copper, molybdenum, niobium, iron, nickel, cobalt, manganese, and mixtures thereof.

13. An electrolyte for an electrical energy power source, the electrolyte comprising:
a) a first monomer comprising a acryloyl or allyl functionality plus a cyano group;
b) a second monomer comprising at least one α-unsaturated functionality; and
c) a thermal initiator mixed with an alkali metal salt and at least one organic solvent.

14. The electrolyte of claim 13 wherein the first monomer is 2-cyanoethyl acrylate.

15. The electrolyte of claim 13 wherein second monomer has more than one (methyl)acryloyl functionality.

16. The electrolyte of claim 15 wherein the (methyl)acryloyl second monomer has at least one functional group selected from alkyl, alkyl ether, alkoxylated alkyl, and alkoxylated phenol functional groups.

17. The electrolyte of claim 13 wherein the second monomer is selected from the group consisting of dipentaerythritol hexaacrylate, dipentaerythritol pentaacrylate, pentaerythritol tetraacrylate, ethoxylated pentaerythritol tetraacrylate, di(trimethylolpropane)tetraacrylate, trimethylolpropane trimethacrylate, ethoxylated trimethylolpropane triacrylate, ethoxylated bisphenol diacrylate, hexanediol diacrylate, and mixtures thereof.

18. The electrolyte of claim 13 wherein the combined concentrations of the first and second monomers in the electrolyte is about 4% to about 15%, by weight.

19. The electrolyte of claim 13 wherein the organic solvent is selected from the group consisting of propylene carbonate, ethylene carbonate, butylene carbonate, acetonitrile, dimethyl sulfoxide, dimethyl formamide, dimethyl acetamide, γ-valerolactone, γ-butyrolactone, N-methyl-pyrrolidinone, and mixtures thereof.

20. The electrolyte of claim 13 wherein the initiator is selected from the group consisting of 1,1′-azobis(cyclohexanecarbonitrile), benzoyl peroxide, 4,4-azobis(4-cyanovaleric acid), lauroyl peroxide, 1,1-bis(tert-butylperoxy)cyclohexane, 1,1-bis(tert-amylperoxy)cyclohexane, and mixtures thereof.

21. The electrolyte of claim 13 wherein the alkali metal salt is selected from the group consisting of LiPF₆, LiBF₄, LiAsF₆, LiSbF₆, LiClO₄, Li[(C₂O₄)₂B], Li₂B₁₀Cl₁₀, Li₂B₁₀Br₁₀, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₃F, LiB(C₆H₅)₄, LiCF₃SO₃, and mixtures thereof.

22. A method for providing an electrochemical cell, comprising the steps of:
a) providing a negative electrode comprising an anode active material contacted to an anode current collector;
b) providing a positive electrode comprising a cathode active material contacted to a positive current collector;
c) providing a separator;
d) preparing an electrolyte comprising:
i) a first monomer comprising a acryloyl or allyl functionality plus a cyano group;
ii) a second monomer comprising at least one α-unsaturated functionality; and
iii) a thermal initiator mixed with an alkali metal salt and at least one organic solvent; and
e) heating the separator soaked with the electrolyte to polymerize the electrolyte in the separator;
f) positioning the separator comprising the polymerized electrolyte intermediate the negative electrode and the positive electrode to provide an electrode assembly; and
g) housing the electrode assembly in a casing.

23. The method of claim 22 including providing the first monomer as 2-cyanoethyl acrylate.

24. The method of claim 22 including providing the second monomer having more than one (methyl)acryloyl functionality.

25. The method of claim 22 including providing the (methyl)acryloyl second monomer having at least one functional group selected from alkyl, alkyl ether, alkoxylated alkyl, and alkylated phenol functional groups.

26. The method of claim 22 including selecting the second monomer from the group consisting of dipentaerythritol hexaacrylate, dipentaerythritol pentaacrylate, pentaerythritol tetraacrylate, ethoxylated pentaerythritol tetraacrylate, di(trimethylolpropane)tetraacrylate, trimethylolpropane trimethacrylate, ethoxylated trimethylolpropane triacrylate, ethoxylated bisphenol diacrylate, hexanediol diacrylate, and mixtures thereof.

27. The method of claim 22 including providing the combined concentrations of the first and second monomers in the electrolyte being about 4% to about 15%, by weight.

28. The method of claim 22 including selecting the organic solvent from the group consisting of propylene carbonate, ethylene carbonate, butylene carbonate, acetonitrile, dimethyl sulfoxide, dimethyl formamide, dimethyl acetamide, γ-valerolactone, γ-butyrolactone, N-methyl-pyrrolidinone, and mixtures thereof.

29. The method of claim 22 including selecting the initiator from the group consisting of 1,1′-azobis(cyclohexanecarbonitrile), benzoyl peroxide, 4,4-azobis(4-cyanovaleric acid), lauroyl peroxide, 1,1-bis(tert-butylperoxy)cyclohexane, 1,1-bis(tert-amylperoxy)cyclohexane, and mixtures thereof.
